(19) United States
(12) Patent Application Publication
(10) Pub. No.: US 2026/0369160 A1
(43) Pub. Date: Nov. 19, 2026

(54) SELECTING SUSTAINABLE ROADSIDE UNITS FOR VEHICLE COMMUNICATION

(71) Applicant: International Business Machines Corporation, Armonk, NY (US)

(72) Inventors: Charan ACHARYA CHANDRASHEKAR, Bangalore (IN); Rachana VISHWANATHULA, Hyderabad (IN); Mukesh KUMAR, Bangalore (IN); Prabhu S. PADASHETTY, Bangalore (IN)

(21) Appl. No.: 19/211,784

(22) Filed: May 19, 2025

(51) Int. Cl. G08G 1/01; B60W 60/00; G01C 21/00; G08G 1/052

(52) U.S. Cl. CPC G08G 1/0116; G01C 21/3893; G08G 1/052; B60W 60/001; B60W 2556/45

(57) ABSTRACT

In some implementations, a computer system may receive sustainability data identifying sustainability parameters associated with a plurality of roadside units (RSUs), and may receive external parameters that impact the sustainability data. The computer system may calculate sustainability scores for different time periods for each of the plurality of RSUs based on the sustainability data and the external parameters, and may associate the sustainability scores with a navigation map. The computer system may provide, to a vehicle, a list of RSUs, from the plurality of RSUs, that the vehicle will encounter on a route and sustainability scores associated with the list of RSUs for the different time periods.

### BACKGROUND

The field of intelligent transportation systems encompasses various technologies applied to transportation networks. Roadside units (RSUs) are a component of the transportation infrastructure and enable communication and information exchange with vehicles.

### SUMMARY

Some aspects described herein relate to a method. The method may include receiving sustainability data identifying sustainability parameters associated with a plurality of roadside units (RSUs), and receiving external parameters that impact the sustainability data. The method may include calculating sustainability scores for different time periods for each of the plurality of RSUs based on the sustainability data and the external parameters, and providing the sustainability scores to a navigation system.

Some aspects described herein relate to a computer system of a vehicle. The computer system may include a processor set, one or more computer-readable storage media, and program instructions stored on the one or more computer-readable storage media to cause the processor set to perform operations. The operations may include determining whether an RSU communication is required during a route, and receiving a list of RSUs that the vehicle will encounter on the route. The operations may include receiving sustainability scores associated with the list of RSUs for different time periods, and calculating encounter times to the RSUs in the list of RSUs. The operations may include identifying respective sustainability scores for the list of RSUs based on the encounter times, and selecting an RSU from the list of RSUs based on the respective sustainability scores.

Some aspects described herein relate to a computer program product. The computer program product may include one or more computer-readable storage media and program instructions stored on the one or more computer-readable storage media to perform operations. The operations may include receiving sustainability data identifying sustainability parameters associated with a plurality of RSUs, and receiving external parameters that impact the sustainability data. The operations may include calculating sustainability scores for different time periods for each of the plurality of RSUs based on the sustainability data and the external parameters, and associating the sustainability scores with a navigation map associated with a vehicle.

### BRIEF DESCRIPTION OF THE DRAWINGS

FIG. 1 is a diagram of an example computing environment for selecting sustainable RSUs for vehicle communication, as described herein.

FIGS. 2A-2F are diagrams of an example associated with selecting sustainable RSUs for vehicle communication.

FIGS. 3 and 4 are flowcharts of example processes associated with selecting sustainable RSUs for vehicle communication.

### DETAILED DESCRIPTION

The following detailed description of example implementations refers to the accompanying drawings. The same reference numbers in different drawings may identify the same or similar elements.

Vehicle-to-Infrastructure (V2I) communication is a component of intelligent transportation systems that enable vehicles to exchange data with roadside units (RSUs) and other infrastructure elements. The increasing demand for data-intensive applications, such as autonomous vehicles and smart traffic management, has led to a growing need for efficient and reliable V2I communication. However, existing methods for selecting an optimal RSU for data exchange typically rely on factors such as proximity, network congestion, and resource availability, without considering sustainability factors and external factors like weather conditions. The lack of consideration for sustainability can lead to suboptimal choices, resulting in increased carbon emissions, heat generation, and energy consumption. Furthermore, with ever-growing concerns about climate change and pollution, governments are implementing stricter regulations and standards to address environmental concerns. Thus, current methods for providing vehicle and RSU communications consume computing resources (e.g., processing resources, memory resources, communication resources, and/or the like), networking resources, and/or the like associated with selecting nonoptimal RSUs that consume more energy than other similarly situated RSUs, requiring more energy sources for the selected nonoptimal RSUs, handling excessive greenhouse gas emissions caused by the selected optimal RSUs, and/or the like.

Some implementations described herein provide a computer system for selecting sustainable RSUs for vehicle communication. For example, the computer system may receive sustainability data identifying sustainability parameters associated with a plurality of RSUs, and may receive external parameters that impact the sustainability data. The computer system may calculate sustainability scores for different time periods for each of the plurality of RSUs based on the sustainability data and the external parameters, and may associate the sustainability scores with a navigation map. The computer system may provide, to a vehicle, a list of RSUs, from the plurality of RSUs, that the vehicle will encounter on a route and sustainability scores associated with the list of RSUs for the different time periods.

In this way, the computer system selects sustainable RSUs for vehicle communication. For example, the computer system may receive sustainability parameters associated with RSUs and may calculate sustainability scores for different time periods for each of the RSUs based on the sustainability parameters and external parameters. The computer system may utilize the sustainability scores with a navigation system, and may provide, to a vehicle, a list of RSUs that the vehicle will encounter on a route and sustainability scores associated with the list of RSUs for the different time periods. The vehicle may request a reservation with an RSU of the list at an encounter time associated with the RSU, and the computer system may establish the reservation for the vehicle with the RSU at the encounter time. The vehicle may then perform a communication with the RSU based on the reservation. Thus, the computer system conserves computing resources, networking resources, and/or the like that would otherwise have been consumed by selecting nonoptimal RSUs that consume more energy than other similarly situated RSUs, requiring more energy sources for the selected nonoptimal RSUs, handling excessive greenhouse gas emissions caused by the selected optimal RSUs, and/or the like.

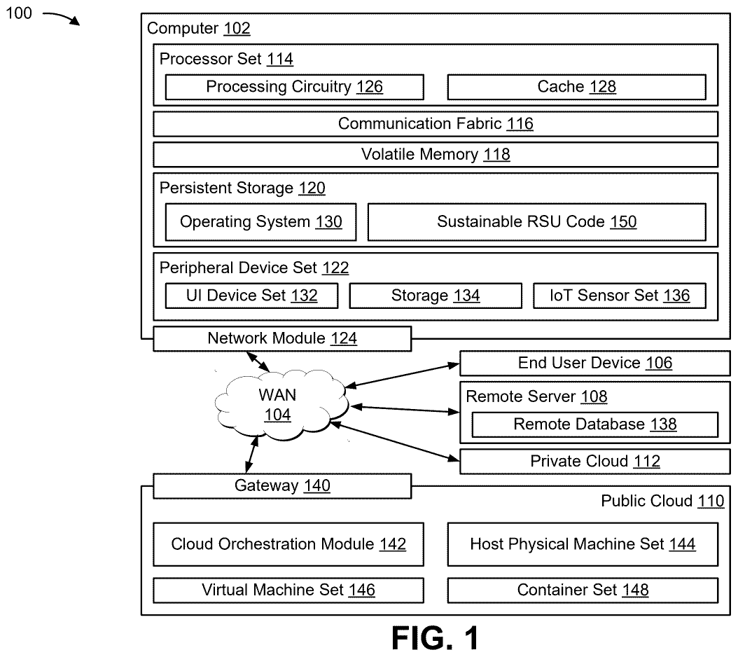

FIG. 1 is a diagram of an example computing environment 100 for selecting sustainable RSUs for vehicle communication, as described herein.

Computing environment 100 contains an example of an environment for the execution of at least some of the computer code involved in performing the inventive methods, such as sustainable RSU code 150 (e.g., code for selecting sustainable RSUs for vehicle communication). In addition to sustainable RSU code 150, computing environment 100 includes, for example, a computer 102, a wide area network (WAN) 104, an end user device (EUD) 106, a remote server 108, a public cloud 110, and a private cloud 112. In this embodiment, computer 102 includes a processor set 114 (including processing circuitry 126 and a cache 128), a communication fabric 116, a volatile memory 118, persistent storage 120 (including an operating system 130 and sustainable RSU code 150, as identified above), a peripheral device set 122 (including a user interface (UI) device set 132, storage 134, and an Internet of Things (IoT) sensor set 136), and a network module 124. Remote server 108 includes a remote database 138. Public cloud 110 includes a gateway 140, a cloud orchestration module 142, a host physical machine set 144, a virtual machine set 146, and a container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in sustainable RSU code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

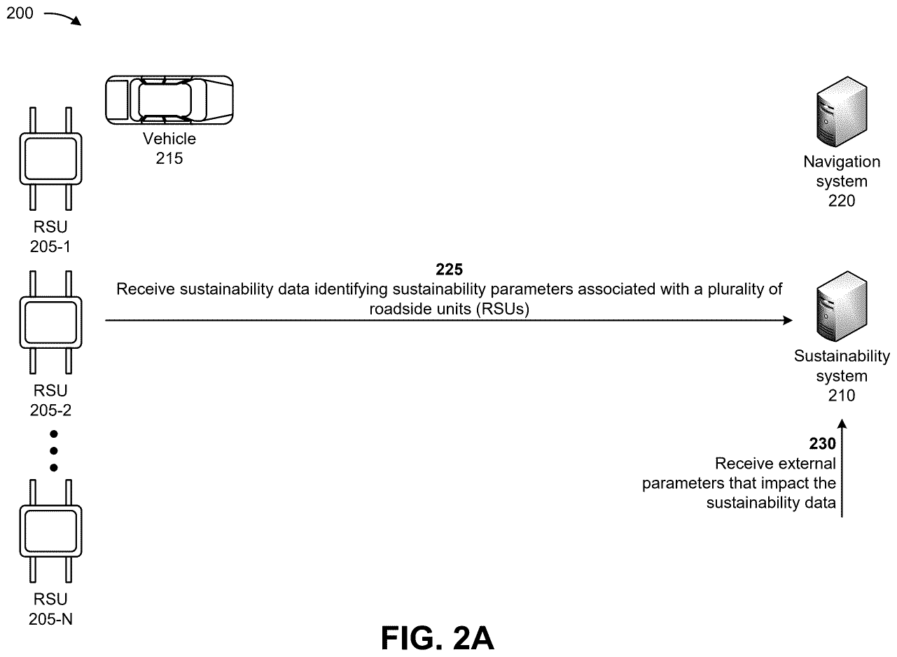

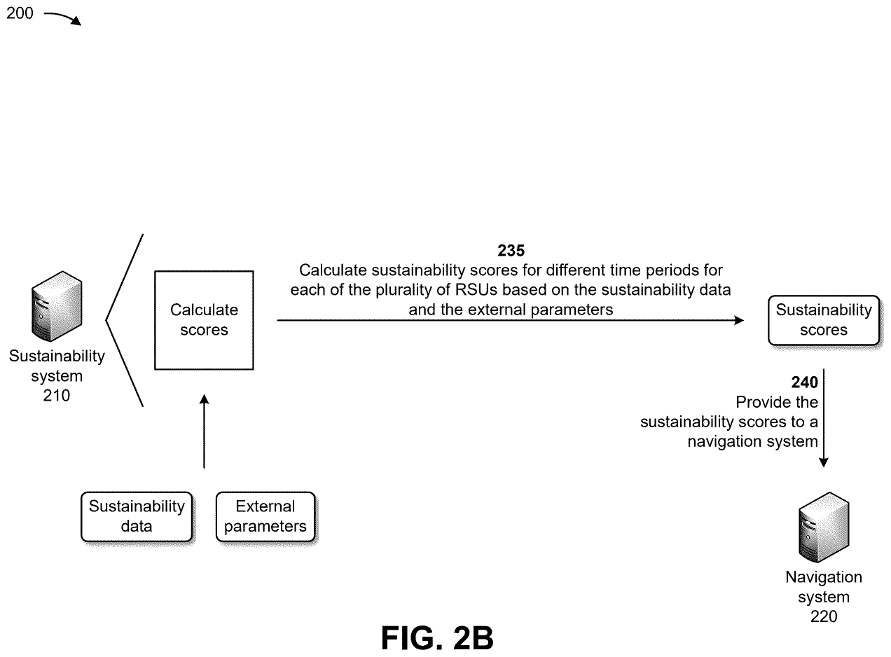

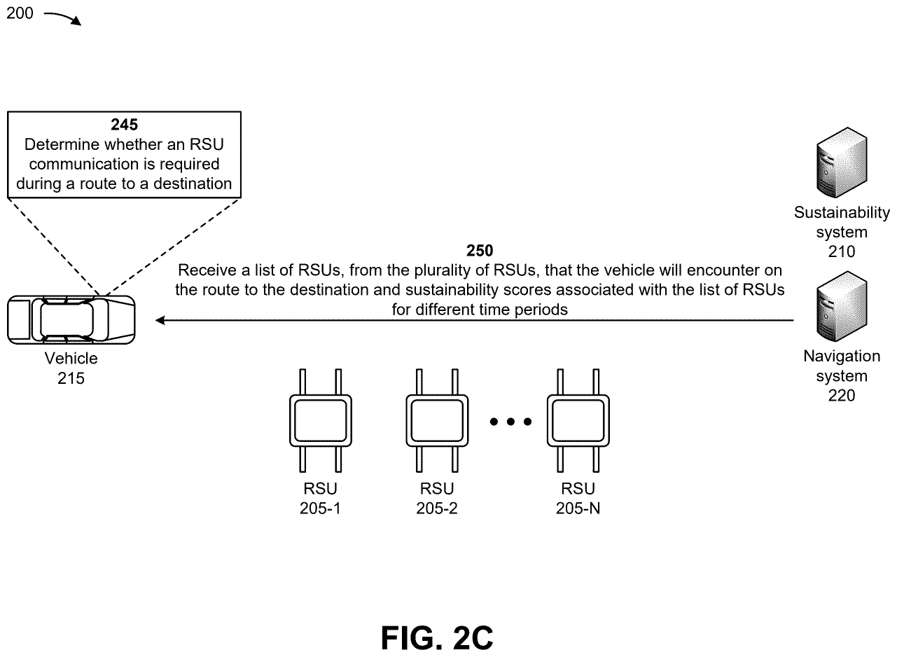

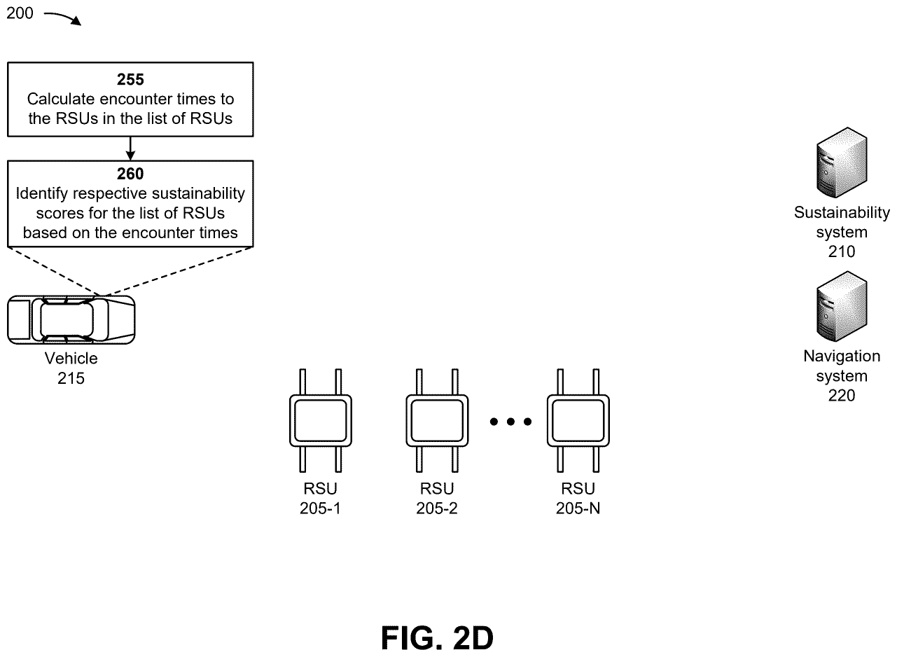

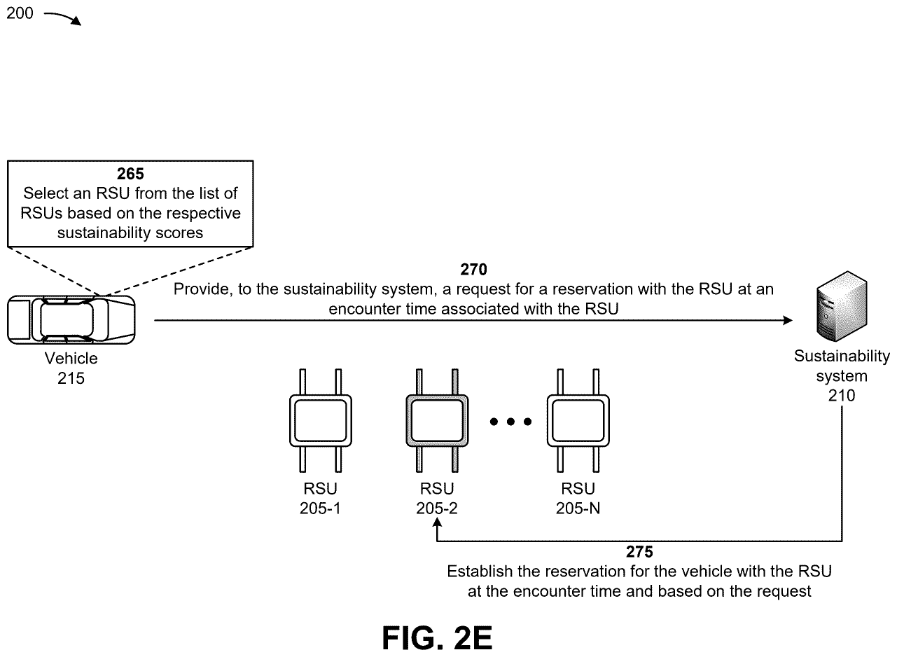

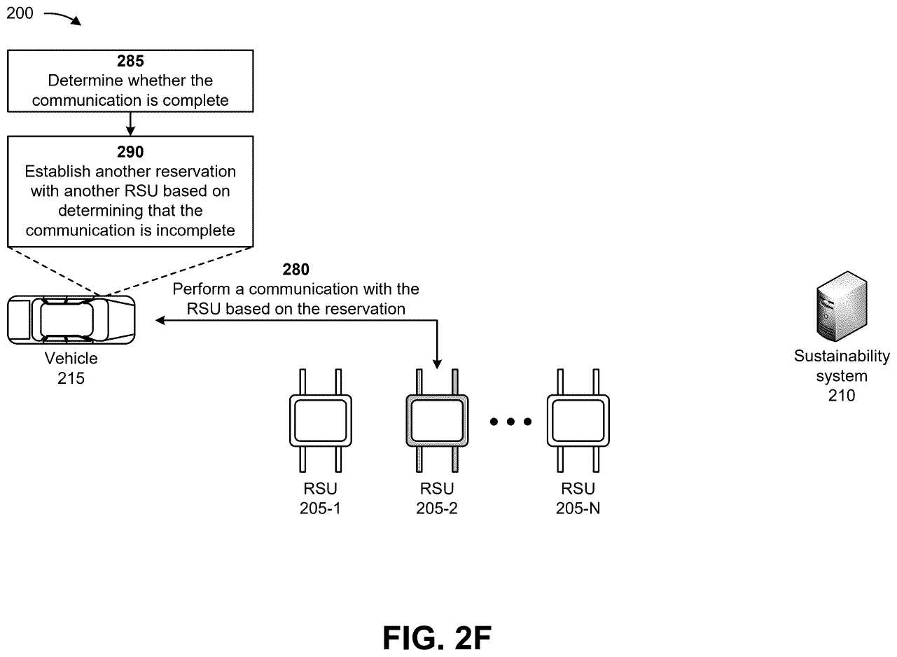

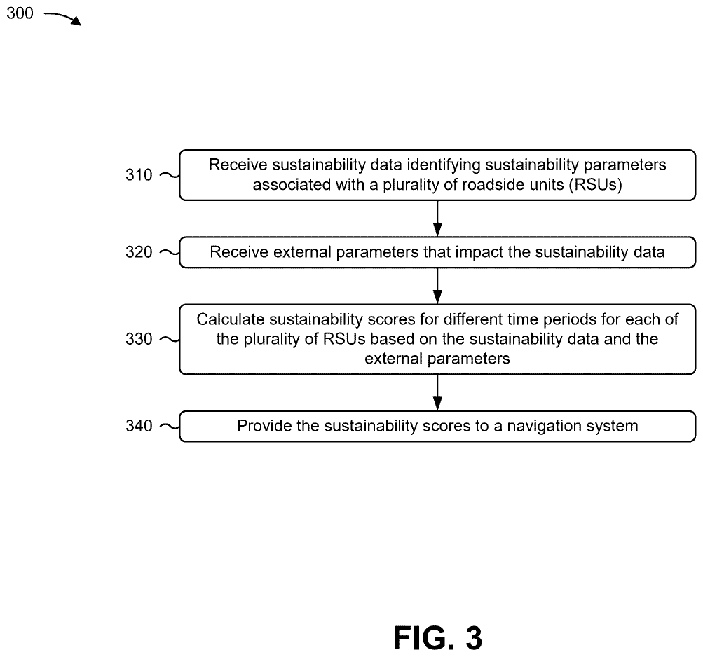

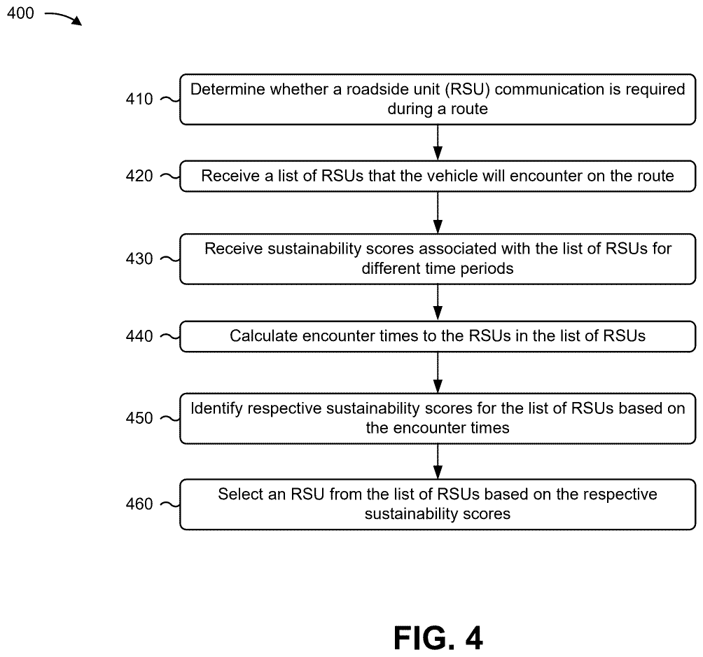

The code included in the sustainable RSU code 150 typically includes at least some of the computer code involved in performing one or more operations described herein, such as the operations of implementation 200 in FIGS. 2A-2F and the processes described in FIGS. 3 and 4.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the computing environment 100 may perform one or more functions described as being performed by another set of devices of the computing environment 100.

FIGS. 2A-2F are diagrams of an example 200 associated with selecting sustainable RSUs for vehicle communication. As shown in FIGS. 2A-2F, the example 200 includes a plurality of RSUs 205 (e.g., RSU 205-1 through RSU 205-N) associated with a sustainability system 210, a vehicle 215 (e.g., an autonomous vehicle, a semi-autonomous vehicle, or a manually-operated vehicle), and a navigation system 220. Each of the RSUs 205 and the vehicle 215 (e.g., a vehicle control unit of the vehicle 215) may correspond to the computer 102 and/or the end user device 106. The sustainability system 210 and the navigation system 220 may correspond to the computer 102, the remote server 108, a system provided by the public cloud 110, and/or a system provided by the private cloud 112. Further details of the RSUs 205, the sustainability system 210, the vehicle 215, and the navigation system 220 are provided elsewhere herein. Although a single vehicle 215 is depicted in the figures, in some implementations, the RSUs 205, the sustainability system 210, and/or the navigation system 220 may be associated with multiple vehicles 215.

In some implementations, each RSU 205 may be equipped with computing resources and storage capabilities, enabling RSUs 205 to perform local processing, analysis, or storage of data offloaded by vehicles 215. This can be particularly useful for tasks that require significant computational resources or historical data analysis. Additionally, the RSUs 205 may include Internet connectivity, allowing the RSUs 205 to download media content such as traffic updates, weather forecasts, news, entertainment, or advertising messages from the Internet and cache the media content locally for distribution to vehicles 215 within their coverage area.

As shown in FIG. 2A, and by reference number 225, the sustainability system 210 may receive sustainability data identifying sustainability parameters associated with the plurality of RSUs 205. For example, the sustainability system 210 may receive the sustainability data from various sources. In some implementations, each RSU 205 may be equipped with sensors and IoT devices that collect and transmit data on various sustainability parameters, such as carbon units generated per unit of work for each of the plurality of RSUs 205, a power source for each of the plurality of RSUs 205, energy consumption by each of the plurality of RSUs 205, carbon emissions by each of the plurality of RSUs 205, and/or the like. The sensors and IoT devices may provide the sustainability parameters to the sustainability system 210, and the sustainability system 210 may receive the sustainability parameters. Alternatively, or additionally, manufacturers and suppliers of the RSUs 205 may provide the sustainability system 210 with sustainability parameters of their products, such as energy efficiency of each of the RSUs 205, material usage of each of the RSUs 205, ages of the plurality of RSUs 205, and/or the like.

In some implementations, the sustainability parameters may include a parameter identifying carbon units generated per unit of work for each of the plurality of RSUs 205, a parameter identifying a power source for each of the plurality of RSUs 205, a parameter identifying energy consumption (e.g., electricity, fuel, or renewable energy) by each of the plurality of RSUs 205, a parameter identifying carbon emissions by each of the plurality of RSUs 205, a parameter identifying water usage and management by each of the plurality of RSUs 205, a parameter identifying waste generation and disposal by each of the plurality of RSUs 205, a parameter identifying material usage and recycling of each of the plurality of RSUs 205, and/or the like.

In some implementations, the sustainability parameters may include characteristics or attributes that are inherent to the plurality of RSUs 205 and can impact carbon and heat footprints of the plurality of RSUs 205. In some implementations, the sustainability parameters influencing the carbon and generated heat footprints of the plurality of RSUs 205 may include hardware efficiencies associated with the plurality of RSUs 205, workload intensities associated with the plurality of RSUs 205, cooling efficiencies associated with the plurality of RSUs 205, renewable energy usages associated with the plurality of RSUs 205, and/or the like. The hardware efficiency of each of the plurality of RSUs 205 may be based on factors such as a type and model (e.g., different RSU models have varying levels of power consumption and heat generation), storage capacity (e.g., higher storage capacities often require more power and generate more heat), age and maintenance history (e.g., older or poorly maintained hardware may be less efficient and generate more heat), and/or the like. The workload intensity of each of the plurality of RSUs 205 may be based on factors such as data throughput (e.g., higher data throughput rates may require more power and generate more heat), request rates (e.g., higher request rates may require more power and generate more heat), a type of workload (e.g., different workloads, such as streaming, transactional, or batch processing, have varying levels of power consumption and heat generation), and/or the like. The cooling efficiency of each RSU 205 may be based on factors such as ambient temperature (e.g., higher ambient temperatures may require more power and generate more heat), humidity levels (e.g., higher humidity levels may reduce cooling efficiency and increase power consumption), airflow rates (e.g., poor airflow rates may reduce cooling efficiency and increase power consumption), and/or the like. The renewable energy used by each RSU 205 may be based on factors such as renewable energy source (e.g., different renewable energy sources, such as solar, wind, and hydroelectric, have varying levels of power generation and carbon footprint), renewable energy capacity (e.g., higher renewable energy capacities may reduce reliance on non-renewable energy sources and decrease carbon footprint), and/or the like.

As further shown in FIG. 2A, and by reference number 230, the sustainability system 210 may receive external parameters that impact the sustainability data. For example, the sustainability system 210 may receive external parameters that impact the sustainability data from a variety of sources, such as the sensors and IoT devices of the plurality of RSUs 205, government agencies and regulatory bodies, weather and climate services, traffic management systems, and/or the like. In some implementations, the external parameters may include temperature readings, humidity readings, and/or the like received from the sensors and IoT devices of the plurality of RSUs 205. Alternatively, or additionally, the external parameters may include data received from government agencies and regulatory bodies, such as carbon pricing and emission trading schemes, energy efficiency standards, environmental regulations, and/or the like affecting the plurality of RSUs 205. Alternatively, or additionally, the external parameters may include data received from weather and climate services, such as temperature and precipitation records, weather forecasts and warnings, climate projections and scenario planning, and/or the like affecting the plurality of RSUs 205. Alternatively, or additionally, the external parameters may include data received from traffic management systems, such as current vehicular traffic conditions, predicted vehicular traffic conditions, and/or the like associated with the plurality of RSUs 205.

As shown in FIG. 2B, and by reference number 235, the sustainability system 210 may calculate sustainability scores for different time periods for each of the plurality of RSUs 205 based on the sustainability data and the external parameters. For example, the sustainability system 210 may calculate sustainability scores for different time periods for each of the plurality of RSUs 205 by using a combination of the sustainability data and the external parameters. In some implementations, the sustainability system 210 may assign weights and priorities to each of the sustainability parameters and the external parameters based on their relative importance and relevance to the sustainability of each of the RSUs 205. For example, energy consumption and carbon emissions may be assigned higher weights than water usage or waste generation. The sustainability system 210 may use various methods to determine the weights and priorities, such as an analytic hierarchy process, a Delphi method, a pairwise comparison, a multi-criteria decision analysis, and/or the like.

In some implementations, the sustainability system 210 may normalize the sustainability parameters and the external parameters to ensure that the parameters are on the same scale and can be compared and combined. Normalization may include converting the sustainability parameters and the external parameters to a standard unit, such as a percentage or a ratio, to remove differences in units and scales. The sustainability system 210 may use various normalization methods, such as min-max normalization, z-score normalization, percentage normalization, ratio normalization, and/or the like. In some implementations, the sustainability system 210 may calculate the sustainability scores for each RSU 205 by combining the weighted and normalized sustainability parameters and external parameters. For example, the sustainability system 210 may calculate the sustainability scores using a weighted sum model, a weighted product model, multiple linear regression, a neural network model, and/or the like. The sustainability scores may be expressed as a numerical value, a percentage, or a categorical rating (e.g., low, medium, or high). The sustainability system 210 may calculate the sustainability scores for each RSU 205 and for different time periods, such as hourly, daily, weekly, monthly, or yearly, to reflect changes in sustainability performance over time.

In some implementations, the sustainability system 210 may calculate the sustainability scores for different time periods by applying the weighted and normalized sustainability parameters and external parameters to a specific time period. For example, the sustainability system 210 may calculate the sustainability scores for a daily time period by using the energy consumption and carbon emissions data from the RSU sensors and IoT devices, and the weather patterns and climate trends data from the weather and climate services. The sustainability scores for a particular RSU 205 may vary at different time periods due to time of day (e.g., temperatures may be cooler at night than during the day), weather (e.g., sunny days may heat the RSU 205 more so than cloudy days), temperature (e.g., hotter days may heat the RSU 205 more than cooler days), traffic congestion (e.g., utilization of the RSU 205 by vehicles 215 may peak during rush hours), and/or the like. The sustainability system 210 may use various time period-based calculation methods, such as moving averages, exponential smoothing, seasonal decomposition, time series analysis, and/or the like.

In one example, the sustainability system 210 may calculate a sustainability score for an RSU 205 based on the following parameters: energy consumption (weight: 0.3), carbon emissions (weight: 0.2), water usage (weight: 0.1), waste generation (weight: 0.1), regulatory requirements (weight: 0.1), and weather patterns (weight: 0.1). The sustainability system 210 may normalize the data to ensure that it is on the same scale. For example, the energy consumption data may be normalized to a percentage of a maximum energy consumption. The sustainability system 210 may calculate a weighted sum of the normalized data to obtain the sustainability score, as follows:

Sustainability score=(0.3×Energy consumption)+(0.2×Carbon emissions)+(0.1×Water usage)+(0.1×Waste generation)+(0.1×Regulatory requirements)+(0.1×Weather patterns).

As further shown in FIG. 2B, and by reference number 240, the sustainability system 210 may provide the sustainability scores to the navigation system 220. For example, the sustainability system 210 may provide the sustainability scores to the navigation system 220 through various interfaces and protocols. In some implementations, the sustainability system 210 may integrate with the navigation system 220 through APIs. The sustainability system 210 may transmit the sustainability scores to the navigation system 220 using API calls, and the navigation system 220 may retrieve the sustainability scores and incorporate the sustainability scores into navigation maps provided to vehicles 215. Alternatively, or additionally, the sustainability system 210 may stream the sustainability scores to the navigation system 220 in real-time using data streaming protocols. This may enable the navigation system 220 to receive the sustainability scores as they are generated and update the navigation maps accordingly. Alternatively, or additionally, the sustainability system 210 may export the sustainability scores to files, and transfer the files to the navigation system 220 through file transfer protocols. The navigation system 220 may then import the files and update the navigation maps. Once the sustainability system 210 provides the sustainability scores to the navigation system 220, the navigation system 220 can incorporate the scores into the navigation maps. In some implementations, the navigation system 220 may use various models to determine the most sustainable routes for vehicles 215, taking into account the sustainability scores, traffic patterns, road conditions, and/or the like.

Alternatively, the sustainability system 210 may assign the sustainability scores to navigation maps generated by the navigation system 220 and provided to vehicles 215. For example, the sustainability system 210 may receive the navigation maps from the navigation system 220 and may assign the sustainability scores to the navigation maps based on locations and the sustainability scores of the RSUs 205 during a time period. The sustainability system 210 may utilize various methods to assign the sustainability scores to the navigation maps. In some implementations, the sustainability system 210 may use geospatial coordinates to tag the sustainability scores to specific locations on the navigation map. This may enable the sustainability scores to be linked to specific RSUs 205 and locations on the map. Alternatively, or additionally, the sustainability system 210 may assign the sustainability scores to each RSU 205 on the navigation map based on its sustainability performance. Alternatively, or additionally, the sustainability system 210 may calculate the sustainability scores for entire routes, taking into account the sustainability performance of each RSU 205 along the route.

Once the sustainability scores are assigned to the navigation maps, the sustainability system 210 or the navigation system 220 may provide the maps to vehicles 215 through various interfaces. In some implementations, the sustainability system 210 or the navigation system 220 may provide the navigation maps with the sustainability scores to vehicles 215 through in-vehicle infotainment systems, such as dashboards or head-up displays. Alternatively, or additionally, the sustainability system 210 or the navigation system 220 may provide the navigation maps with the sustainability scores to vehicles 215 through mobile applications, such as smartphone applications or tablet applications. Alternatively, or additionally, the sustainability system 210 or the navigation system 220 may provide the navigation maps with the sustainability scores to vehicles 215 through cloud-based services, such as subscription-based navigation services. By providing sustainability scores with navigation maps, the sustainability system 210 may enable vehicles 215 to make more informed decisions about the most sustainable routes to take, reducing their environmental impact and promoting more sustainable transportation practices.

As shown in FIG. 2C, and by reference number 245, the vehicle 215 may determine whether an RSU communication is required during a route to a destination. For example, the vehicle 215 may determine whether an RSU communication is required during a route to a destination based on various factors. In some implementations, the vehicle 215 may determine that an RSU communication is required to upload data from the vehicle 215 to an RSU 205, to download data from the RSU 205 to the vehicle 215, and/or the like. The vehicle 215 may determine whether an RSU communication is required during the route to the destination by identifying the RSUs 205 located along the route, and determining a coverage area of each RSU 205, including a range and connectivity options. The vehicle 215 may check for traffic congestion or road closures along the route that may require an RSU communication, and may evaluate communication requirements, such as data transmission needs or emergency services. Based on the aforementioned steps, the vehicle 215 may determine whether an RSU communication is required during the route.

In one example, the vehicle 215 may utilize a route planning model to determine a most optimal route to the destination. The model may require information about traffic patterns and road conditions that may be provided by an RSU 205. In such an example, the vehicle 215 may determine that an RSU communication is required. In another example, the vehicle 215 may be traveling along a route, and an RSU 205 that provides connectivity services may be located along the route. The vehicle 215 may determine that the RSU 205 is located within a coverage area of the vehicle 215 and that there is a high probability of traffic congestion near the RSU 205. Based on this information, the vehicle 215 may determine that an RSU communication is required during the route to ensure continuous connectivity and to avoid traffic congestion. In still another example, the vehicle 215 may be traveling in an area with superior cellular connectivity that the vehicle 215 may utilize to transmit and/or receive information. In such an example, the vehicle 215 may determine that an RSU communication is not required since the cellular service is more than sufficient.

As further shown in FIG. 2C, and by reference number 250, the vehicle 215 may receive a list of RSUs 205, from the plurality of RSUs 205, that the vehicle 215 will encounter on the route to the destination and sustainability scores associated with the list of RSUs 205 for different time periods. For example, the vehicle 215 may provide an address or a name of the destination to the sustainability system 210 or the navigation system 220. The sustainability system 210 or the navigation system 220 may calculate the route to the destination based on the address or the name of the destination. In some implementations, the sustainability system 210 or the navigation system 220 may utilize digital maps that include information about the location of the RSUs 205 along with other road infrastructure, such as roads, intersections, and traffic signals to determine the list of RSUs 205 that the vehicle 215 will encounter on the route. Alternatively, or additionally, the sustainability system 210 or the navigation system 220 may utilize global positioning system (GPS) coordinates to determine the location of the vehicle 215 and the locations of the RSUs 205. The sustainability system 210 or the navigation system 220 may utilize the locations of the vehicle 215 and the RSUs 205 to determine the list of RSUs 205 that the vehicle 215 will encounter on the route. Alternatively, or additionally, the sustainability system 210 or the navigation system 220 may utilize traffic patterns, such as traffic volume, speed, and congestion, to determine the most likely route the vehicle 215 will take and the RSUs 205 that vehicle 215 will encounter (e.g., the list of RSUs 205). This information may be obtained from traffic sensors, cameras, or other data sources.

In some implementations, the sustainability system 210 or the navigation system 220 may use a route planning model to determine the most optimal route from a current location of the vehicle 215 to the destination. The route planning model may take into account factors such as traffic patterns, road conditions, and time of day. The sustainability system 210 or the navigation system 220 may utilize an RSU proximity model to determine which RSUs 205 are closest to the route of the vehicle 215. The RSU proximity model may use GPS coordinates and maps to calculate the distance between the vehicle 215 and each RSU 205. The sustainability system 210 or the navigation system 220 may utilize an RSU filtering model to filter out RSUs 205 that are not relevant to the route of the vehicle 215 or that are not operational.

In some implementations, the sustainability system 210 or the navigation system 220 may calculate the most optimal route from the current location of the vehicle 215 to the destination using the route planning model, and may identify the RSUs 205 that are closest to the route using the RSU proximity model. The sustainability system 210 or the navigation system 220 may filter out RSUs 205 that are not relevant to the route or that are not operational using the RSU filtering model, and may sort the remaining RSUs 205 in the order they will be encountered by the vehicle 215. The sustainability system 210 or the navigation system 220 may generate the list of RSUs 205 that the vehicle 215 will encounter on the route to the destination, along with their location and operational status.

In some implementations, the sustainability system 210 or the navigation system 220 may provide the sustainability scores associated with the list of RSUs 205 for different time periods to the vehicle 215. For example, the sustainability system 210 or the navigation system 220 may generate user interfaces that include roads of the route, traffic of the route, directions for the route, representations of the RSUs 205 in the list of RSUs 205, and the sustainability scores associated with the representations of the RSUs 205 for different time periods.

As shown in FIG. 2D, and by reference number 255, the vehicle 215 may calculate encounter times to the RSUs 205 in the list of RSUs 205. For example, the vehicle 215 may calculate times when the vehicle 215 will encounter the RSUs 205 in the list of RSUs 205 based on GPS coordinates indicating a current location and a velocity of the vehicle 215. The vehicle 215 may utilize the locations of each RSU 205 in the list received from the sustainability system 210 or the navigation system 220, and may utilize map data to determine the road network and the route to each RSU 205 in the list of RSUs 205. The vehicle 215 may utilize traffic patterns, such as traffic volume, speed, and congestion, to estimate the time it takes to reach each RSU 205 in the list of RSUs 205. In some implementations, the vehicle 215 may calculate the distance from a current location to each RSU 205 using the GPS coordinates and the map data, and may estimate the time it takes to reach each RSU 205 based on the current velocity, the distance to the RSU 205, and traffic patterns. In some implementations, the vehicle 215 may use route planning models to determine the most optimal route to each RSU 205, taking into account traffic patterns and road conditions. The vehicle 215 may calculate the encounter time at each RSU 205 based on the time estimation, the route planning model, and the current time.

In one example, if the vehicle 215 is traveling at a velocity of v meters per second and the distance between the vehicle 215 and the RSU 205 is d meters. The vehicle 215 may estimate the encounter time at the RSU 205 using the following equation:

Encounter time=Current time+(d/v).

As further shown in FIG. 2D, and by reference number 260, the vehicle 215 may identify respective sustainability scores for the list of RSUs 205 based on the encounter times. For example, the vehicle 215 may retrieve the sustainability scores for each RSU 205 in the list of RSUs 205 provided by the sustainability system 210 or the navigation system 220. In some implementations, the vehicle 215 may filter the sustainability scores based on the encounter times. The vehicle 215 may use a time-based filtering model to select only the sustainability scores that are valid during the time period when the vehicle 215 will encounter the RSU 205. For example, if the vehicle 215 will encounter RSU 205-1 at 10:00 AM, the vehicle 215 may select only the sustainability scores that are valid between 9:00 AM and 11:00 AM. In some implementations, the vehicle 215 may assign weights to each sustainability score based on the encounter time and the characteristics of the RSU 205. The weights may be used to prioritize certain sustainability scores over others. For example, the vehicle 215 may assign a higher weight to sustainability scores that are valid during peak hours or for RSUs 205 that are located in areas with high traffic volume. The vehicle 215 may calculate the weighted sustainability scores for each RSU 205 by multiplying the sustainability score by the weight. The weighted sustainability scores may be used to prioritize certain RSUs 205 over others. The vehicle 215 may rank the RSUs 205 based on their weighted sustainability scores.

As shown in FIG. 2E, and by reference number 265, the vehicle 215 may select an RSU 205 from the list of RSUs 205 based on the respective sustainability scores. For example, the vehicle 215 may select an RSU 205 from the list of RSUs 205 based on the respective sustainability scores by using various decision-making models and techniques. In some implementations, the vehicle 215 may select, from the ranked list of RSUs 205 (e.g., ranked based on the weighted sustainability scores), the RSU 205 with the highest ranked sustainability score as the most sustainable option. In some implementations, the vehicle 215 may use various decision-making models to select an RSU 205 from the list of RSUs 205 based on the respective sustainability scores. For example, the vehicle 215 may utilize multi-attribute decision making (e.g., that evaluates multiple attributes or criteria to select the best option) to evaluate the sustainability scores for each RSU 205 in the list and to select the most sustainable option. Alternatively, the vehicle 215 may utilize an analytic hierarchy process (e.g., that uses a hierarchical structure to evaluate multiple attributes or criteria) to evaluate the sustainability scores for each RSU 205 in the list and to select the most sustainable option. Alternatively, the vehicle 215 may use fuzzy logic to evaluate the sustainability scores for each RSU 205 in the list and to select the most sustainable option.

As further shown in FIG. 2E, and by reference number 270, the vehicle 215 may provide, to the sustainability system 210, a request for a reservation with the RSU 205 at an encounter time associated with the RSU 205. For example, the vehicle 215 may provide, to the sustainability system 210, the request for the reservation with the RSU 205 at the encounter time associated with the RSU 205 by using various communication protocols. The vehicle 215 may determine the encounter time associated with the RSU 205 based on a current location, speed, and trajectory of the vehicle 215. The vehicle 215 may create a reservation request that includes an RSU identifier (e.g., a unique identifier of the RSU 205), an encounter time (e.g., a time at which the vehicle 215 expects to encounter the RSU 205), a vehicle identifier (e.g., a unique identifier of the vehicle 215), and a type of reservation requested (e.g., charging, data transfer, and/or the like). The vehicle 215 may format the reservation request using a standardized data structure, such as JavaScript Object Notation (JSON). The vehicle 215 may send the reservation request to the sustainability system 210 using a wireless communication protocol. The sustainability system 210 may receive the reservation request and may process reservation request to determine whether the reservation can be granted. The sustainability system 210 may send a reservation response back to the vehicle 215, indicating whether the reservation has been granted or denied.

As further shown in FIG. 2E, and by reference number 275, the sustainability system 210 may establish the reservation for the vehicle 215 with the RSU 205 at the encounter time and based on the request. For example, the sustainability system 210 may receive the reservation request from the vehicle 215, and may check the availability of the RSU 205 at the encounter time, based on the request, to ensure that it is not already reserved by another vehicle 215. In some implementations, the sustainability system 210 may use a scheduling model to manage the availability of the RSU 205. The sustainability system 210 may check the eligibility of the vehicle 215 to make a reservation with the RSU 205. The sustainability system 210 may use a set of rules or criteria (e.g., a type, size, or energy consumption by the vehicle 215) to determine whether the vehicle 215 is eligible to make a reservation with the RSU 205. The sustainability system 210 may calculate the duration of the reservation based on the encounter time, the speed of the vehicle 215, and a capacity of the RSU 205. The sustainability system 210 may use a set of models to optimize the reservation duration to minimize congestion and maximize the use of the RSU 205. The sustainability system 210 may create a reservation record that includes the RSU identifier of the RSU 205, the encounter time, the vehicle identifier of the vehicle 215, the type of reservation requested (e.g., charging, data transfer, and/or the like), and a duration of the reservation. The sustainability system 210 may update a schedule of the RSU 205 to reflect the new reservation with the vehicle 215. The sustainability system 210 may use a scheduling model to manage the schedule of the RSU 205 and to ensure that the RSU 205 is not overbooked. The sustainability system 210 may send, to the vehicle 215, a reservation confirmation that includes the RSU identifier of the RSU 205, the encounter time, the vehicle identifier of the vehicle 215, the type of reservation requested, and the duration of the reservation.

Upon receiving a reservation request, the RSU 205 may evaluate a current load and may determines whether the RSU 205 can accommodate the request of the vehicle 215 at the specified encounter time. If the RSU 205 confirms the reservation, the RSU 205 may send back a confirmation to the sustainability system 210 and/or the vehicle 215. In scenarios where an RSU 205 can only partially fulfill a data offload request due to capacity constraints, the vehicle 215 may split the data offload among multiple RSUs 205, selecting the next most sustainable RSU 205 to complete the data transfer.

As shown in FIG. 2F, and by reference number 280, the vehicle 215 may perform a communication with the RSU 205 based on the reservation. For example, the vehicle 215 may establish a connection with the RSU 205 (e.g., at the encounter time and based on the reservation) using a wireless communication protocol. The vehicle 215 may authenticate the reservation with the RSU 205 by sending a reservation identifier or an authentication token to the RSU 205. The RSU 205 may verify the reservation identifier or the authentication token to ensure that the vehicle 215 has a valid reservation. In some implementations, the communication may include the vehicle 215 transferring data to or from the RSU 205 based on the reservation. The data may include vehicle information, such as speed, location, and energy consumption, or infrastructure information, such as traffic signals, road conditions, and weather. Alternatively, or additionally, the communication may include the vehicle 215 receiving data from the RSU 205, such as traffic signals, road conditions, and weather. The vehicle 215 may utilize this data to optimize its route, speed, and energy consumption. Alternatively, or additionally, the communication may include the vehicle 215 receiving electricity (e.g., if the vehicle 215 is an electric vehicle) from the RSU 205.

In some implementations, the vehicle 215 may terminate the connection with the RSU 205 when the communication is complete. The vehicle 215 may send a termination signal to the RSU 205 to indicate that the communication is complete. Alternatively, the vehicle 215 may terminate the connection with the RSU 205 prior to completion of the communication (e.g., a download or an upload) if the vehicle 215 loses connectivity with the RSU 205 (e.g., due driving away from the RSU 205). The vehicle 215 and the RSU 205 may use various communication protocols to exchange data, such as a dedicated short-range communication protocol designed for V2I and vehicle-to-vehicle (V2V) communication, a wireless communication protocol that uses cellular networks to exchange data, hypertext transfer protocol (HTTP), a file transfer protocol, and/or the like. The dedicated short range communication protocol may establish and maintain high-speed data connections between the vehicle 215 and the RSU 205 during the brief period they are within range of each other. The communication between the vehicle 215 and the RSU 205 may provide several benefits, such as improved safety (e.g., the vehicle 215 may receive real-time traffic information and weather conditions, which can help improve safety on the road), reduced traffic congestion (e.g., the vehicle 215 may receive traffic information and optimize its route to avoid congestion, which can help reduce traffic congestion), energy efficiency (e.g., the vehicle 215 may receive energy consumption data and optimize its energy usage, which can help reduce energy consumption and emissions), and/or the like.

In some implementations, the communication may include any other operation related to data exchange between the vehicle 215 and the RSUs 205. For example, the communication may include operations such as synchronizing vehicle software updates, sharing vehicle diagnostics and performance data, real-time traffic and road condition updates, infotainment content provisioning, and emergency communication protocols. By facilitating these additional data exchange operations, implementations described herein may provide a comprehensive and versatile communication framework between vehicles 215 and RSUs 205, enhancing both the driving experience and overall vehicle performance.

As further shown in FIG. 2F, and by reference number 285, the vehicle 215 may determine whether the communication is complete. For example, the vehicle 215 may determine whether the communication is complete based on whether a data transfer to or from the RSU 205 is complete, whether an electricity transfer to the vehicle 215 from the RSU 205 is complete, and/or the like. In some implementations, the vehicle 215 may determine that the communication is complete at a time when the vehicle 215 loses connectivity with the RSU 205. If the communication is complete, the vehicle 215 may not seek connectivity with another RSU 205 provided further along the route. Alternatively, the vehicle 215 may determine that the communication is incomplete at the time when the vehicle 215 loses connectivity with the RSU 205. If the communication is incomplete, the vehicle 215 may seek connectivity with another RSU 205 in order to complete the communication.

In some implementations, the vehicle 215 may use a timer-based approach to determine whether the communication is complete. In this approach, the vehicle 215 may set a timer for a predetermined amount of time, and may wait for the communication to complete. If the communication is not complete within the predetermined time, the vehicle 215 may assume that the communication has failed or is incomplete. Alternatively, or additionally, the vehicle 215 may use an acknowledgment-based approach to determine whether the communication is complete. In this approach, the vehicle 215 may send a message to the RSU 205 and may wait for an acknowledgment from the RSU 205. If the RSU 205 sends an acknowledgment, the vehicle 215 may assume that the communication is complete. If the RSU 205 does not send an acknowledgment within a predetermined amount of time, the vehicle 215 may assume that the communication has failed or is incomplete. Alternatively, or additionally, the vehicle 215 may utilize a data-integrity-based approach to determine whether the communication is complete. In this approach, the vehicle 215 may check the integrity of the data received from the RSU 205 to ensure that the data is complete and accurate. If the data is incomplete or corrupted, the vehicle 215 may determine that the communication is incomplete.

As further shown in FIG. 2F, and by reference number 290, the vehicle 215 may establish another reservation with another RSU 205 based on determining that the communication is incomplete. For example, if the vehicle 215 determines that the communication is incomplete, the vehicle 215 may identify another RSU 205 provided further along the route, and may reserve a time slot with the other RSU 205 for completion of the communication. The sustainability system 210 may establish the other reservation with the other RSU 205 based on a request from the vehicle 215, and the vehicle 215 may complete the communication with the other RSU 205 based on the other reservation.

In this way, a computer system (e.g., the sustainability system 210) selects sustainable RSUs for vehicle communication. For example, the computer system may receive sustainability parameters associated with RSUs and may calculate sustainability scores for different time periods for each of the RSUs based on the sustainability parameters and external parameters. The computer system may utilize the sustainability scores with a navigation system, and may provide, to a vehicle, a list of RSUs that the vehicle will encounter on a route and sustainability scores associated with the list of RSUs for the different time periods. The vehicle may request a reservation with an RSU of the list at an encounter time associated with the RSU, and the computer system may establish the reservation for the vehicle with the RSU at the encounter time. The vehicle may then perform a communication with the RSU based on the reservation. Thus, the computer system conserves computing resources, networking resources, and/or the like that would otherwise have been consumed by selecting nonoptimal RSUs that consume more energy than other similarly situated RSUs, requiring more energy sources for the selected nonoptimal RSUs, handling excessive greenhouse gas emissions caused by the selected optimal RSUs, and/or the like.

As indicated above, FIGS. 2A-2F are provided as an example. Other examples may differ from what is described with regard to FIGS. 2A-2F. The number and arrangement of devices shown in FIGS. 2A-2F are provided as an example. In practice, there may be additional devices, fewer devices, different devices, or differently arranged devices than those shown in FIGS. 2A-2F. Furthermore, two or more devices shown in FIGS. 2A-2F may be implemented within a single device, or a single device shown in FIGS. 2A-2F may be implemented as multiple, distributed devices. Additionally, or alternatively, a set of devices (e.g., one or more devices) shown in FIGS. 2A-2F may perform one or more functions described as being performed by another set of devices shown in FIGS. 2A-2F.

FIG. 3 is a flowchart of an example process 300 associated with selecting sustainable RSUs for vehicle communication. One or more process blocks of FIG. 3 are performed by a computer system (e.g., computer 102 and/or the sustainability system 210) and/or by another device or a group of devices separate from or including the computer system. Additionally, or alternatively, one or more process blocks of FIG. 3 may be performed by one or more components of computer 102, such as processor set 114, communication fabric 116, volatile memory 118, and/or sustainable RSU code 150.

As shown in FIG. 3, process 300 may include receiving sustainability data identifying sustainability parameters associated with a plurality of RSUs (block 310). For example, the computer system may receive sustainability data identifying sustainability parameters associated with a plurality of RSUs, as described above. In some implementations, the sustainability parameters include a parameter identifying carbon units generated per unit of work for each of the plurality of RSUs, and a parameter identifying a power source for each of the plurality of RSUs.

As further shown in FIG. 3, process 300 may include receiving external parameters that impact the sustainability data (block 320). For example, the computer system may receive external parameters that impact the sustainability data, as described above.

As further shown in FIG. 3, process 300 may include calculating sustainability scores for different time periods for each of the plurality of RSUs based on the sustainability data and the external parameters (block 330). For example, the computer system may calculate sustainability scores for different time periods for each of the plurality of RSUs based on the sustainability data and the external parameters, as described above.

As further shown in FIG. 3, process 300 may include providing the sustainability scores to a navigation system (block 340). For example, the computer system may provide the sustainability scores to a navigation system, as described above. In some implementations, the navigation system is configured to provide, to a vehicle, a list of RSUs, from the plurality of RSUs, that the vehicle will encounter on a route and sustainability scores associated with the list of RSUs for the different time periods.

In some implementations, process 300 includes receiving, from a vehicle, a request for a reservation with an RSU, of the plurality of RSUs, at an encounter time associated with the RSU and the vehicle, and establishing the reservation for the vehicle with the RSU at the encounter time and based on the request. In some implementations, the vehicle is configured to perform a communication with the RSU based on the reservation and at the encounter time.

In some implementations, process 300 includes receiving updated sustainability data, calculating updated sustainability scores for the different time periods for each of the plurality of RSUs based on the updated sustainability data and the external parameters, and providing the updated sustainability scores to the navigation system. In some implementations, process 300 includes receiving updated external parameters, calculating updated sustainability scores for the different time periods for each of the plurality of RSUs based on the sustainability data and the updated external parameters, and providing the updated sustainability scores to the navigation system.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

FIG. 4 is a flowchart of an example process 400 associated with selecting sustainable RSUs for vehicle communication. One or more process blocks of FIG. 4 are performed by a computer system (e.g., computer 102 and/or the vehicle 215) and/or by another device or a group of devices separate from or including the computer system. Additionally, or alternatively, one or more process blocks of FIG. 3 may be performed by one or more components of computer 102, such as processor set 114, communication fabric 116, volatile memory 118, and/or sustainable RSU code 150.

As shown in FIG. 4, process 400 may include determining whether an RSU communication is required during a route (block 410). For example, the computer system may determine whether an RSU communication is required during a route, as described above.

As further shown in FIG. 4, process 400 may include receiving a list of RSUs that the vehicle will encounter on the route (block 420). For example, the computer system may receive a list of RSUs that the vehicle will encounter on the route, as described above. In some implementations, the vehicle is an autonomous vehicle.

As further shown in FIG. 4, process 400 may include receiving sustainability scores associated with the list of RSUs for different time periods (block 430). For example, the computer system may receive sustainability scores associated with the list of RSUs for different time periods, as described above.

As further shown in FIG. 4, process 400 may include calculating encounter times to the RSUs in the list of RSUs (block 440). For example, the computer system may calculate encounter times to the RSUs in the list of RSUs, as described above. In some implementations, calculating the encounter times to the RSUs in the list of RSUs includes calculating the encounter times based on one or more of a speed of the vehicle, traffic conditions associated with the vehicle, or expected arrival times at the RSUs.

As further shown in FIG. 4, process 400 may include identifying respective sustainability scores for the list of RSUs based on the encounter times (block 450). For example, the computer system may identify respective sustainability scores for the list of RSUs based on the encounter times, as described above.

As further shown in FIG. 4, process 400 may include selecting an RSU from the list of RSUs based on the respective sustainability scores (block 460). For example, the computer system may select an RSU from the list of RSUs based on the respective sustainability scores, as described above.

In some implementations, process 400 includes establishing a reservation with the RSU at an encounter time associated with the RSU, and performing a communication with the RSU based on the reservation. In some implementations, process 400 includes determining that the communication is incomplete after the encounter time associated with the RSU, and establishing another reservation with another RSU based on determining that the communication is incomplete. In some implementations, the communication is one of uploading data from the vehicle to the RSU or downloading data from the RSU to the vehicle. In some implementations, process 400 includes selecting another RSU from the list of RSUs based on the respective sustainability scores, establishing another reservation with the other RSU at another encounter time associated with the other RSU, and performing another communication with the other RSU based on the other reservation.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various implementations of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving sustainability data identifying sustainability parameters associated with a plurality of roadside units (RSUs);
receiving external parameters that impact the sustainability data;
calculating sustainability scores for different time periods for each of the plurality of RSUs based on the sustainability data and the external parameters; and
providing the sustainability scores to a navigation system.

2. The method of claim 1, wherein the navigation system is configured to provide, to a vehicle, a list of RSUs, from the plurality of RSUs, that the vehicle will encounter on a route and sustainability scores associated with the list of RSUs for the different time periods.

3. The method of claim 1, further comprising:
receiving, from a vehicle, a request for a reservation with an RSU, of the plurality of RSUs, at an encounter time associated with the RSU and the vehicle; and
establishing the reservation for the vehicle with the RSU at the encounter time and based on the request.

4. The method of claim 3, wherein the vehicle is configured to perform a communication with the RSU based on the reservation and at the encounter time.

5. The method of claim 1, wherein the sustainability parameters include a parameter identifying carbon units generated per unit of work for each of the plurality of RSUs, and a parameter identifying a power source for each of the plurality of RSUs.

6. The method of claim 1, further comprising:
receiving updated sustainability data;
calculating updated sustainability scores for the different time periods for each of the plurality of RSUs based on the updated sustainability data and the external parameters; and
providing the updated sustainability scores to the navigation system.

7. The method of claim 1, further comprising:
receiving updated external parameters;
calculating updated sustainability scores for the different time periods for each of the plurality of RSUs based on the sustainability data and the updated external parameters; and
providing the updated sustainability scores to the navigation system.

8. A computer system of a vehicle, the computer system comprising:
a processor set;
one or more computer-readable storage media; and
program instructions stored on the one or more computer-readable storage media to cause the processor set to perform operations, comprising:
determining whether a roadside unit (RSU) communication is required during a route;
receiving a list of RSUs that the vehicle will encounter on the route;
receiving sustainability scores associated with the list of RSUs for different time periods;
calculating encounter times to the RSUs in the list of RSUs;
identifying respective sustainability scores for the list of RSUs based on the encounter times; and
selecting an RSU from the list of RSUs based on the respective sustainability scores.

9. The computer system of claim 8, wherein the operations further comprise:
establishing a reservation with the RSU at an encounter time associated with the RSU; and
performing a communication with the RSU based on the reservation.

10. The computer system of claim 9, wherein the operations further comprise:
determining that the communication is incomplete after the encounter time associated with the RSU; and
establishing another reservation with another RSU based on determining that the communication is incomplete.

11. The computer system of claim 9, wherein the communication is one of uploading data from the vehicle to the RSU or downloading data from the RSU to the vehicle.

12. The computer system of claim 8, wherein calculating the encounter times to the RSUs in the list of RSUs comprises:
calculating the encounter times based on one or more of a speed of the vehicle, traffic conditions associated with the vehicle, or expected arrival times at the RSUs.

13. The computer system of claim 8, wherein the vehicle is an autonomous vehicle.

14. The computer system of claim 8, wherein the operations further comprise:
selecting another RSU from the list of RSUs based on the respective sustainability scores;
establishing another reservation with the other RSU at another encounter time associated with the other RSU; and
performing another communication with the other RSU based on the other reservation.

15. A computer program product, comprising:
one or more computer-readable storage media; and
program instructions stored on the one or more computer-readable storage media to perform operations comprising:
receiving sustainability data identifying sustainability parameters associated with a plurality of roadside units (RSUs);
receiving external parameters that impact the sustainability data;
calculating sustainability scores for different time periods for each of the plurality of RSUs based on the sustainability data and the external parameters; and
associating the sustainability scores with a navigation map associated with a vehicle.

16. The computer program product of claim 15, wherein the operations further comprise:
providing, to the vehicle and via the navigation map, a list of RSUs, from the plurality of RSUs, that the vehicle will encounter on a route; and
providing, to the vehicle and via the navigation map, sustainability scores associated with the list of RSUs for the different time periods.

17. The computer program product of claim 16, wherein the operations further comprise:
receiving, from the vehicle, a request for a reservation with an RSU, of the list of RSUs, at an encounter time associated with the RSU and the vehicle; and
establishing the reservation for the vehicle with the RSU at the encounter time and based on the request.

18. The computer program product of claim 15, wherein the sustainability parameters include a parameter identifying carbon units generated per unit of work for each of the plurality of RSUs, and a parameter identifying a power source for each of the plurality of RSUs.

19. The computer program product of claim 15, wherein the operations further comprise:
receiving updated sustainability data;
calculating updated sustainability scores for the different time periods for each of the plurality of RSUs based on the updated sustainability data and the external parameters; and
associating the updated sustainability scores with the navigation map.

20. The computer program product of claim 15, wherein the operations further comprise:
receiving updated external parameters;
calculating updated sustainability scores for the different time periods for each of the plurality of RSUs based on the sustainability data and the updated external parameters; and
associating the updated sustainability scores with the navigation map.
